(19) United States
(12) Patent Application Publication
(10) Pub. No.: US 2015/0032604 A1
(43) Pub. Date: Jan. 29, 2015

(54) MERCHANT DATA CLEANSING IN CLEARING RECORD BASED ON TARGETED MERCHANTS

(71) Applicant: MASTERCARD INTERNATIONAL INCORPORATED, Purchase, NY (US)

(72) Inventors: Gary Kearns, Purchase, NY (US); Cristobel von Walstrom, Greenwich, CT (US); Gary Randall Horn, O'Fallon, MO (US); Bruce Mac Nair, Stamford, CT (US); Michele Mowrey, Chesterfield, MO (US)

(21) Appl. No.: 14/339,043

(22) Filed: Jul. 23, 2014

Related U.S. Application Data
(60) Provisional application No. 61/857,670, filed on Jul. 23, 2013.

(51) Int. Cl. G06Q 20/02; G06F 17/30

(52) U.S. Cl. CPC G06Q 20/023; G06F 17/30303
USPC 705/39

(57) ABSTRACT

A network operator intermediates a cashless transaction by sending a payment device issuer an outbound clearing data file enriched with cleansed merchant data. Issuers that choose to participate in the merchant data cleansing service are provided with the cleansed, and optionally augmented, merchant information. Before providing the cleansed and/or augmented merchant information, a determination is made of whether a “do not recognize” call is likely, based upon a determination by a computing device of whether or not the merchant is on a “watch-list” of merchants. The “watch-list” is previously generated based upon one or several factors, including whether or not a minimum number or percentage of previous transactions have resulted in charge-backs, whether DNR transactions associated with the merchant were previously reported, or if an acquirer, issuer, or third-party payment provider recommends the merchant for inclusion.

### CROSS-REFERENCES TO RELATED APPLICATIONS

This application claims the priority benefit under 35 U.S.C. §119(e) of U.S. Provisional Patent Application Ser. No. 61/857,670 filed on Jul. 23, 2013. The complete disclosure of this prior application is incorporated by reference in this application for all purposes.

This application is related to U.S. patent application Ser. No. 14/138,854, filed Dec. 23, 2013 and Ser. No. 13/548,983, filed Jul. 13, 2012 (presently issued as U.S. Pat. No. 8,620,806), both entitled “Merchant Data Cleansing in Clearing Record.” The complete disclosures of these applications are incorporated by reference in their entireties.

### BACKGROUND

1. Field of the Disclosure

The present disclosure relates to electronic transaction processing. More specifically, the present disclosure is directed to an improved method, system, and computer software product for identifying whether to provide standardized or cleansed data identifying a merchant involved in a transaction as part of a clearing record of that transaction by performing an initial step of determining whether a “do not recognize” call is likely for charges issued to the customer from the merchant in question, after having generated a “watch-list” of merchants in a manner as disclosed herein.

2. Brief Discussion of Related Art

The use of payment devices for a broad spectrum of cashless transactions has become ubiquitous in the current economy, accounting for hundreds of billions of dollars in transactions during 2010 alone. FIG. 1 of the present disclosure displays the process and parties involved in the completion of a cashless transaction using a payment device. The process and parties involved may be visualized for example as presented in FIG. 1, and the process may be thought of as a cycle, as indicated by arrow 10. A device holder 12 presents a payment device 14 to a merchant 16 as payment for goods and/or services. For simplicity the payment device 14 is depicted as a credit card, although those skilled in the art would know the payment device 14 is emblematic of any transaction device, real or virtual (which could include, by way of non-limiting example, a credit card, debit card, contactless RFID-enabled device, near-field communication-enabled smartphone, electronic wallet, and transponder devices, as well as all presently-existing or after arising equivalents) which the device holder 12 as payor and/or the source of funds uses to complete the transaction.

In cases where the merchant 16 has an established merchant account with an acquiring bank (also known as the “acquirer”) 20, the merchant communicates with the acquirer to secure payment on the transaction. An acquirer 20 is a party or entity, typically a bank, which is authorized by the network operator 22 to acquire network transactions on behalf of customers of the acquirer 20 (e.g. a merchant 16). Occasionally, the merchant 16 does not have an established merchant account with an acquirer 20, but may secure payment on a transaction through a third-party payment provider 18. The third-party payment provider 18 does have a merchant account with an acquirer 20, and is further authorized by the acquirer 20 and the network operator 22 to acquire payments on network transactions on behalf of sub-merchants. In this way, the merchant 16 may be authorized and able to accept the payment device 14 from the device holder 12, despite not having a merchant account with an acquirer 20.

The acquirer 20 routes the transaction request to the network operator 22. The data included in the transaction request will identify the source of funds for the transaction. With this information, the network operator routes the transaction to the issuer 24. An issuer 24 is a party or entity, typically a bank, which is authorized by the network operator 22 to issue payment devices 14 on behalf of its customers (e.g. device holder 12) for use in transactions to be completed on the network. The issuer 24 also provides funding for the transaction to the network provider 22 for transactions that are approved in the process described. The issuer 24 may approve or authorize the transaction request based on criteria such as a device holder's credit limit, account balance, or in certain instances more detailed and particularized criteria including transaction amount, merchant classification, etc., which may optionally be determined in advance in consultation with the device holder and/or a party having financial ownership or responsibility for the account(s) funding the payment device 14, if not solely the device holder 12.

The decision of the issuer 24 to authorize or decline the transaction is routed through the network operator 22 and acquirer 20, ultimately to the merchant 16 at the point of sale. At present, this entire process is typically carried out by electronic communication, and under routine circumstances (i.e. with a valid device, adequate funds, etc.) may be completed in a matter of seconds. It permits the merchant 16 to engage in transactions with device holder 12, and the device holder 12 to partake of the benefits of cashless payment, while the merchant 16 is assured that payment is secured. This is enabled without the need for a preexisting one-to-one relationship between the merchant 16 and every device holder 12 with whom they may engage in a transaction.

The authorization may also be separate in time from the consummation of the transaction. In some cases, an authorization is taken by a merchant 16, but payment is not made until goods are delivered or the services performed at some time later. In any case, on a periodic basis, (e.g. daily), the merchant 16 will submit a batch of completed and authorized transactions to the acquirer 20 to receive payment. The acquirer 20, in turn, looks to the network operator for payment in a process called “clearing.” The clearing records, or list of cleared transactions including data relevant thereto in form and content specified by the network operator 22, is transmitted to the issuer 24.

The issuer 24 may then look to its customer, e.g. device holder 12, or other party having financial ownership or responsibility for the account(s) funding the payment device 14, for payment on approved transactions, for example through an existing line of credit where the payment device 14 is a credit card, or from funds on deposit where the payment device 14 is a debit card. The issuer 24 will prepare a periodic statement 26 listing transactions on the account of a device holder 12, including merchant data as provided by the network operator 22.

In the context of completing transactions and obtaining payment, one problem that frequently arises is when a device holder 12 Does Not Recognize (“DNR”) a transaction on billing statement 26. An estimated 13-14 MM dispute cases are opened every year based upon this. At an industry average of $25 per claim, case resolution costs the industry approximately $350 MM per year, not counting call-center costs and related expenses. These estimates do not include the call center costs of the initial phone call from the device holder 12, call time with a dispute specialist prior to opening the case, and write-offs undertaken by the issuer 24 when the transaction amount does not reach a certain threshold. Frequently, this situation is not caused by actual fraud on the device holder 12 as to the nature of the transactions on the billing statement 26, but rather poor information being provided to the device holder 12 from the acquirer 20, particularly when the merchant 16 is separated from the acquirer 20 by a third-party payment provider 18.

Some common sources of poor merchant data quality include
Merchants 16 shift between acquirers 20;
Several merchants 16 may be partnered with multiple acquirers 20;
Merchant 16 DBA Name, City Name, and Address include non-standard abbreviation variations;
Acquirer 20 has a data integrity deficit identifying one or more merchants 16;
One or more acquirers 20 interpret the network operator's 22 reporting guidance differently from their peers; and
Acquirers 20 are not obligated to tell a network operator 22 when they make changes or reassign merchant identifiers.

Two main characteristics of “poor quality” merchant data are
1. Incomplete Information—Acquirers 20 leaving key data fields blank; and
2. Inaccurate Information—Wrong data supplied by acquirers 20 either by mistake or interpretation.

In addition to the advantage of reducing DNR transaction costs to the industry, improvements in merchant data quality are of benefit to the acquirers 20 where they do not have direct control over merchant data quality, for example in the cases where the merchant 16 is separated from the acquirer 20 by third-party payment provider 18. A need presents itself for a manner of reducing DNR transactions experienced by improving the quality of data.

Finding a method of avoiding costs generated by DNR transactions presents an immediate benefit to the industry and the device holder 12 alike. Improvements in merchant data quality are further of tangible benefit to customer-service call centers involved in cashless transaction processing by reducing the number of calls and their associated costs, regardless of which entity on the transaction processing chain is operating the call center (including third-party outsourced providers).

Furthermore, improvements in merchant data quality are of benefit to the acquirers 20 where they do not have direct control over the merchant data quality, for example in the cases where the merchant 16 is separated from the acquirer 20 by a third-party payment provider 18. For example, improvements in data quality may facilitate processing return authorization messages received from the network operator 20, or in their settlement clearing of processed transactions.

In addition to the above-described benefits, among others, to the various parties to the processing of the cashless transaction according to the instant disclosure, valuable benefits accrue to the network operator 20 as well. The network operator may see its own call center costs reduced corresponding with the number of DNR transactions. In addition, reduced DNRs may lead to reduced charge-back requests, which necessarily interrupt the ordinary transaction flow and are a source of dissatisfaction to merchants 16, among others. The improvement of service level to all involved in the cashless transaction chain according to the present disclosure further inures to the benefit of the network operator 20.

Accordingly, the present disclosure provides a method, system, and computer software product presenting a solution whereby merchant data is not cleansed unnecessarily but instead cleansed only if there is a high risk of a “do not recognize” call being issued, saving time, money, and system resources while increasing efficiency.

### SUMMARY OF THE INVENTION

MasterCard International Incorporated, the assignee of the instant application, in its capacity as network operator 22 in the above-described process has developed an improved solution in providing cleansed merchant data through the clearing records in a real-time manner, following a real-time determination of whether or not to actually provide cleansed merchant data through the clearing records. According to the present disclosure before providing cleansed merchant data, an initial determination is made of whether or not the merchant is on a merchant watch-list. If so, and if other conditions are true, the network operator 22 sends the issuer 24 an outbound clearing data file enriched with cleansed merchant data. The initial step of determining whether or not the merchant is on the watch-list indicates, in effect, whether a “do not recognize” call is likely for the charges issued to the customer from the merchant in question. The watch-list is generated in a manner as further described herein. Issuers 24 that choose to participate in the improved merchant data cleansing service are provided with the cleansed, and optionally augmented, merchant information in First and Second Presentment messages on the Accepted outbound clearing files. Providing this data to the issuer 24 may be used to help reduce costs associated with “do not recognize” calls, disputed charges, and charge-backs. With cleansed data provided in the clearing record, a device holder 12 would presumably be given access to this additional cleansed information about the merchant 16 where a transaction took place through statement 26.

Therefore, in order to overcome the aforementioned and other weaknesses, drawbacks, and deficiencies in the known art, provided according to the present disclosure is an improved method, system, and computer software product of intermediating cashless transactions from an acquirer involving a payment device issued by an issuer while utilizing a computing device to make relevant determinations in a realistic time-frame (considering the amount of data involved). According to the present disclosure, a network operator receives a transaction request from acquirer on behalf of a merchant in a transaction clearing record. The transaction request may include data identifying the merchant and the payment device. Next, a merchant check is performed by comparing the data identifying the merchant including in the transaction request with a list of merchants on a merchant watch-list. The merchant watch-list is generated as further discussed herein, in an embodiment of the invention. In response to determining that the merchant is included in the transaction request is part of the watch-list, the network operator then compares the data identifying the merchant to a database including cleansed merchant data entries to determine if a match exists in the database.

In an embodiment of the invention, the watch-list is generated by the computing device. The computing device may add a merchant to the watch-list if either a minimum number of previous transactions or a minimum percentage of previous transactions result in charge-backs of a given time-frame. The given time-frame may be, by means of non-limiting example, one month, two months, six months, and one year. In a further embodiment, the computing device may add a merchant to the watch-list if the network operator determines DNS transactions associated with the merchant have been reported by customers. In still a further embodiment, the computing device adds a merchant to the watch-list at least one of the acquirer, issuer, or third-party payment provider recommend the merchant for inclusion in the watch-list. The watch-list may be housed in a data-warehouse maintained by the network operator.

In response to determining a match exists in the database between a cleansed merchant data entry and the data identifying the merchant in the transaction request, the network operator determines whether the data identifying the merchant in the transaction request should be substituted with the matching cleansed merchant data entry. Further, in response to determining that the data identifying the merchant should be substituted with the matching cleansed merchant data entry, the network operator performs the data substitution. The transaction request is forwarded to the issuer of the payment device.

Alternately or additionally, the network operator may compare the data identifying the merchant to a database including merchant add-on data entries to determine if a match exists in the database. In response to determining a match exists in the database between a merchant add-on data entry and the data identifying the merchant in the transaction request, the network operator may append the merchant add-on data entry to the transaction request before forwarding the transaction request to the issuer of the payment device.

Alternately or additionally, the network operator may compare the data identifying the merchant to a database including merchant aggregation data entries to determine if a match exists in the database. In response to determining a match exists in the database between a merchant aggregation data entry and the data identifying the merchant in the transaction request, the network operator may append the merchant aggregation data entry to the transaction request before forwarding the transaction request to the issuer of the payment device.

Alternately or additionally, the network operator may identifying a subset of transaction requests in the transaction clearing record to be compared to the database based upon at least a part of the data identifying the payment device.

Alternately or additionally, the network operator may append a supplement to the transaction data, the presence of which indicates to the issuing entity that the comparing was performed. The supplement may be further related to the result of the determining if a match exists in the database.

Optionally, according to the present disclosure, performing the data substitution further comprises appending the data identifying the merchant included with the transaction request to the transaction request having the substituted cleansed merchant data.

Optionally, making a determination that the data identifying the merchant in the transaction request should not be substituted with the matching cleansed merchant data entry where the data identifying the merchant in the transaction request is a complete match with the corresponding cleansed merchant data entry.

Alternately or additionally, the network operator may receive a charge-back request from an issuer pertaining to a cleared transaction request, and determine whether the data identifying the merchant in the cleared transaction request had been substituted with the matching cleansed merchant data entry. In response to determining affirmatively that the data identifying the merchant in the cleared transaction request had been substituted with the matching cleansed merchant data entry, the network operator may reverse the substitution. The charge-back request is forwarded to the acquirer of the cleared transaction.

Alternately or additionally, the network operator may determine whether the transaction should be excluded from comparing the data identifying the merchant to a database including cleansed merchant data entries to determine if a match exists in the database based upon a predetermined characteristic of the merchant. The predetermined characteristic of the merchant includes the merchant's country.

The present disclosure further provides for a computer-readable storage medium having a program of instructions thereon which, when executed by a processor or computing device of a computer system, cause the computing device to perform the steps according to the method described above and further herein. The computer-readable storage medium may be transitory or non-transitory in embodiments of the invention. The present disclosure further provides for a system for intermediating cashless transactions from an acquirer involving a payment device issued by an issuer. The system includes a computing device having a processor, and a storage medium having a program of instructions thereon which, when executed by the processor or computing device, cause the computing device to perform the steps according to the method described above and further herein.

These and other purposes, goals and advantages of the present disclosure will become apparent from the following detailed description of example embodiments read in connection with the accompanying drawings.

### BRIEF DESCRIPTION OF THE DRAWINGS

Some embodiments are illustrated by way of example and not limitation in the figures of the accompanying drawings, in which like reference numerals refer to like structures across the several views, and wherein:

FIG. 1 illustrates a cycle for cashless transaction processing;

FIG. 2 illustrates a flowchart depicting a process for implementing merchant data cleansing in clearing records based on targeted merchants according to a first embodiment of the instant disclosure;

FIG. 3 illustrates a flowchart depicting a process for implementing merchant data cleansing in clearing records based on targeted merchants according to a second embodiment of the instant disclosure;

FIG. 4 illustrates a flowchart depicting a process for implementing merchant data cleansing in clearing records based on targeted merchants according to a third embodiment of the instant disclosure;

FIG. 5 illustrates a flow chart depicting a charge-back procedure according to the present disclosure;

FIG. 6 illustrates a network-enabled system according to a further embodiment of the present disclosure;

FIG. 7 illustrates schematically a representative server of the system; and

FIG. 8 illustrates a flowchart depicting a process for generation of a “watch-list” in an embodiment of the invention.

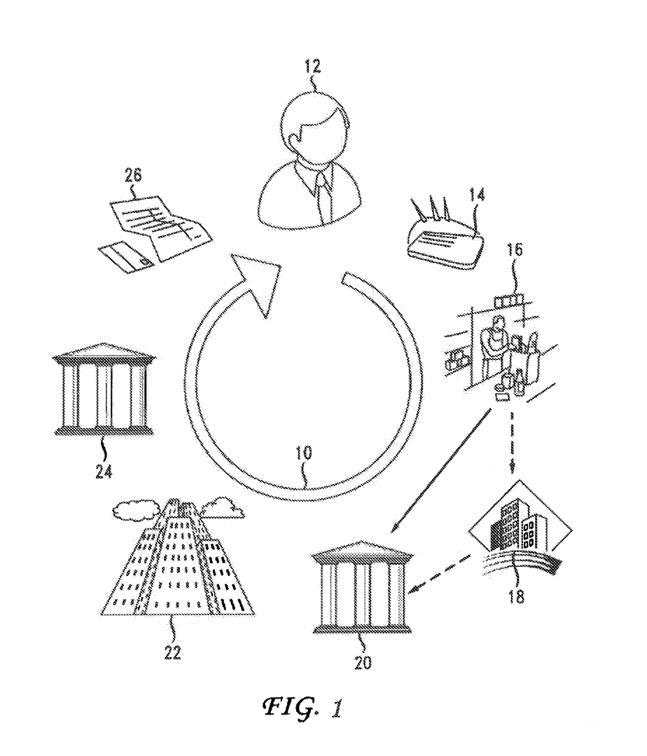

### DETAILED DESCRIPTION

The present system, method, and computer software product is described below with reference to flowchart products according to embodiments of the present disclosure. It will be understood that each block of the flowchart illustrations and/or block diagrams, and combinations of blocks in the flowchart illustrations and/or block diagrams, may be implemented by the computer software instructions as discussed, and/or block diagrams of methods, products, apparatuses (systems), and computer software.

U.S. patent application Ser. No. 14/138,854 (presently published as United States Patent Application Publication 2014/0114848) and Ser. No. 13/548,983 (presently issued as U.S. Pat. No. 8,620,806) have presented a solution to the problems discussed above whereby network operator 22 sends the issuer 24 an outbound clearing data file enriched with cleansed merchant data, so as to provide improved data to the consumer 12 via the billing statement 26. While effective, the invention disclosed therein may lead to a great deal of waste of system resources and time. In practice, a network operator 22 may process cleansed data files which require no cleanup. It may be directed to target particular merchants, whereby associated transactions are directed for cleanup.

Note the process described and depicted herein may require that the issuer 24 has affirmatively enrolled in an improved cleansed merchant data program with the network operator 22. This is so because operation of the improved cleansed merchant data program based on targeted merchants may involve deviations from the data formatting protocols that are previously established, and remain in effect with respect to those issuers not participating in the improved cleansed merchant data program, subject of course to routine and unrelated revisions in the future course of the parties' business. Enrollment may include a request to enroll by or on behalf of the issuer 24, and acceptance by the issuer 24 of terms and conditions of participation in the improved cleansed merchant data program based on targeted merchants.

In response to the enrollment request by issuer 24 and as part of the acceptance of that request by the network operator 22, the issuer 24 may be permitted to select some or all of Interbank Card Association (ICA) numbers and/or Bank Identification Numbers (BIN) associated with that issuer 24, and which make up part of an account number assigned to the payment device 14 issued to device holder 12. This information may be considered to form some part of the transaction data that identifies the payment device in this or other embodiments of the instant disclosure. In this way, network operator 22 can refer to the selection of ICA/BIN, for example via a lookup table, in the ordinary course of processing merchant 16/acquirer 20 transaction requests in order to determine whether to invoke the improved cleansed merchant data program for any particular transaction

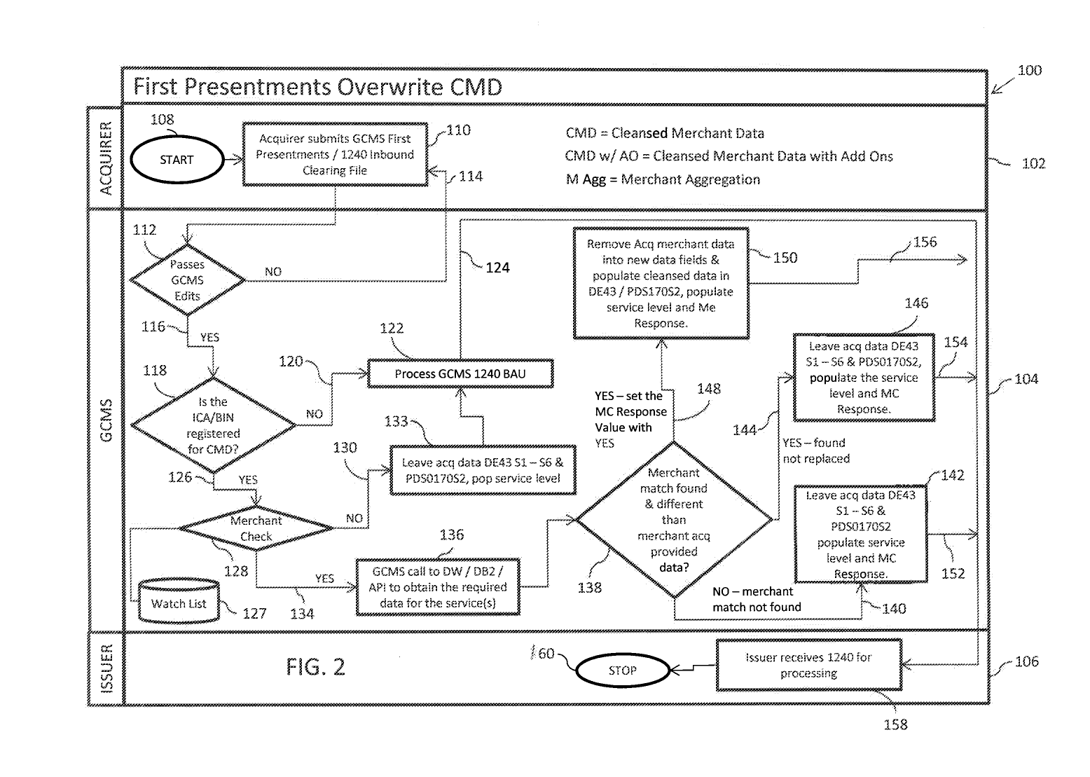

Referring now to FIG. 2, illustrated is a flowchart 100, describing the process for implementing improved merchant data cleansing including a further decision-making process of whether to cleanse merchant data according to a first embodiment of the instant disclosure. The flowchart 100 is divided into three vertical layers, a first layer 102 representing actions of the acquirer 20, a second and intermediate layer 104 representing the actions of a network operator 22, and a third layer 106 representing the actions of an issuer 24. An acquirer 20 begins the process 108 and submits 110 to the network operator 22 the first presentments of completed transactions in an inbound clearing file to clear the transactions. The network operator 22 checks the submission for conformance with its standards 112. If found out of compliance it is rejected and returned 114 to the acquirer 20. If found in compliance, the process proceeds 116.

In the present disclosure, as in previous disclosures, the network operator 20 next determines at 118 (as in previous disclosures) whether the ICA and/or BIN derived from the payment device 14 associated with any particular transaction among those submitted for clearing 110 has previously registered for participation in the improved cleansed merchant data program. If the ICA and/or BIN is not found to be registered for the improved cleansed merchant data program 120, then the transaction is processed normally at 122, i.e. without invoking the features of the improved cleansed merchant data program. The normally processed transaction is then forwarded 124 onto the issuer 24 at step 158.

On the other hand, upon determining that the ICA and/or BIN in question is registered for the improved cleansed merchant data program 126, a “merchant check” is performed 128. In the present disclosure, the merchant check 128 includes a check of the identity of the merchant as contained in the transaction request with a list of merchants on a “watch-list” 127. In this manner, transactions associated with merchants that have a higher propensity to cause a DNR transaction may be targeted and submitted for cleansing without the need to submit all transactions for cleansing.

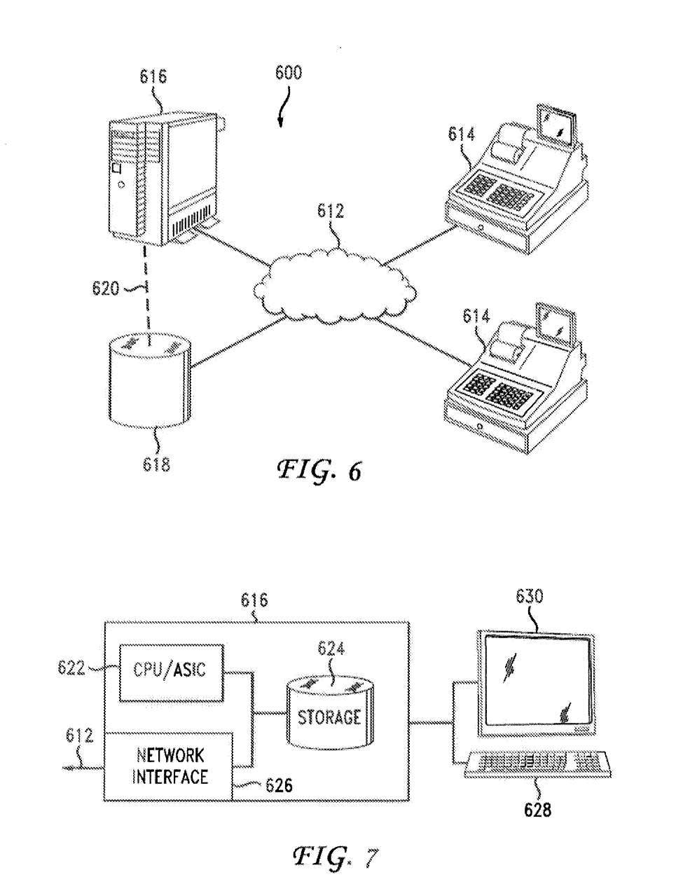

The watch-list 127 may be located in a “data-warehouse” maintained by network operator 20. The network operator may maintain this data-warehouse on a server under control of the network operator 20 (see e.g. FIG. 6 of the present disclosure), or by equivalent computer-implemented means. A computer or some sort of computing device is a necessary element to perform the vast amounts of data organization necessary to operate the presently disclosed method, system, and computer software product. The watch-list 127 against which a merchant check is performed is obtained in one of several possible ways. For example, merchants 16 may be included because of having a certain propensity to generate DNR transactions. According to a first possible criterion, obtaining a watch-list 127 simply comprises tracking all merchants 16 that the network operator 20 observes have been the subject of charge-backs or that the deviceholder indicates he or she did not authorize. Alternately, as part of a determination of whether or not to include a merchant 16 on the watch-list 127, the network operator 20 may evaluate frequency or number of charge-backs associated with the merchant within a given time-frame (e.g. one month, two months, six months, and twelve months), and/or a certain minimum percentage of transactions processed through the merchant 16 that result in charge-backs. According to a second possible criterion of obtaining watch-list 127, the network operator 20 maintains listings of which merchants 16 have not been recognized by customers 12 receiving a billing statement 26. In effect, as a customer or customers 12 contact a call center to report a DNR transaction on his or her bill 26 due to non-recognition of the name of the merchant 16, the network operator 20 is able to keep records as to these occurrences. These records may be used to populate a watch-list 127 maintained in the data-warehouse with associated merchants, as discussed above. Again, frequency may be optionally evaluated in determining whether limitations may be made as to which listings are included with associated merchants in the watch-list 127 based upon the number of complaints within a time period or the number of complaints versus the number of completed transactions. According to a third possible criterion of obtaining a watch-list 127, the network operator 20 maintains listings of which merchants 16 have had queries made regarding them by customers 12 receiving a billing statement 26. As previously, a customer 12 contacts a call center to report a DNR charge on his or her bill 26. The network operator 20 is able to keep records as to these occurrences directly, or as made available by issuers. These records may be used to populate a watch-list 127 maintained in the data-warehouse with associated merchants 16, as discussed above. According to a fourth possible criterion of obtaining a watch-list 127, an acquirer 20, issuer 24, or third-party payment provider 18 may provide or recommend a merchant 16 for inclusion on the watch-list 127 such as, for example, because the merchant was the cause of a DNR transaction. Further, it is envisioned that the watch-list 127 is primarily maintained by the network operator 20. It may be possible to provide edit rights (limited or unlimited) to one or more of the acquirer 20, issuer 24, third-party payment provider 18 to edit the watch-list 127, e.g. to allow adding of a merchant 16. Note, it may be preferred to restrict deletion rights. As will be recognized by those skilled in the art, the criteria described herein for inclusion or exclusion from the watch-list 127 may be used singularly or in combination in various embodiments. Other criteria may be utilized to identify merchants for inclusion on that watch-list 127. In addition, the criteria are provided as non-limiting examples and do not represent an exhaustive list. In addition, discretion of the network operator 20, or other entity, may be relied upon in determining if a merchant should be added to the watch-list 127.

With the watch-list 127, a select, targeted number of merchants may be relied upon for identifying transactions for cleansing. This avoids the need to process all of the transactions from a particular acquirer. Rather, particular merchant-related transactions, those perceived as having a greater propensity for causing a DNR call or transaction, may be processed to the exclusion of other transactions in a more efficient manner. Various factors may be evaluated in maintaining the watch-list 127, such as removal of a merchant 16 if the merchant 16 is not associated with any DNR transactions within a certain timeframe (e.g. one year, etc.).

In the present disclosure, the merchant check 128 includes a check of the identity of the merchant as contained in the transaction request with a list of merchants on a “watch-list” 127. After performance of the merchant check 128 and a determination of whether or not the identity of the merchant is contained in the watch-list 127 (as in the embodiments discussed above), execution proceeds. If it is determined that the identity of the merchant is contained in the merchant list 127, execution proceeds 134 to step 136, where the improved cleansed merchant data process 136 is invoked. The improved cleansed merchant data process looks to a pre-established cleansed merchant database, including cleansed merchant data (i.e. merchant identification data that may be empirically verified and/or formatted according to a more identifiable and/or useful standard from the perspective of the issuer 24 and/or the device holder 12) and cleansed merchant data entries.

On the other hand, after performance of the merchant check 128, if it is determined that the identity of the merchant is not contained in the merchant list 127, execution proceeds 130 to step 133. At step 133 the network operator 22 will leave in place the transaction data supplied by the acquirer 20, which was to have been eligible for replacement or supplementation, in accordance with the improved cleansed merchant data program.

Among the further processing at step 133, the network operator 22 leaves in place the transaction data supplied by the acquirer 20, which would have been eligible for replacement or supplementation in accordance with the improved cleansed merchant data program. The further processing 133 may further supplement the transaction data to indicate to the issuer 24 that the application of the improved cleansed merchant data program to that transaction was suspended. This supplemental indication may include a reason for the suspension of the improved cleansed merchant data program for that transaction, for example if the improved cleansed merchant data program is inapplicable to transactions associated with merchants in a particular country, or simply because the merchant is not a member of the watch-list. Transactions of this type would have been processed under the improved cleansed merchant data program based upon ICA and/or BIN 118, but for restriction based upon the identity of the merchant 128, are thereafter processed 122 using the merchant data supplied by the acquirer 20, and forwarded 124 to the issuer 24.

In addition to or in substitution for the determination 118 where an ICA and/or BIN is used to invoke the improved merchant data cleansing program, other characteristics of the transaction may be used to identify transactions which are to be handled according to the improved merchant data cleansing program. For example, the program described herein is equally applicable to ACH transactions, which are generally distinguished from payment-card transactions in their handling. In such a case, the ACH transactions may be identified according to a bank Routing Transit Number (RTN) associated with the bank holding the account on which ACH transaction funds are drawn, analogous to the inspection of ISA and/or BIN numbers associated with a payment device transaction. In that way, the RTN may form at least a part of the transaction data that identifies the payment device, i.e. a physical check converted to ACH transaction, and/or an ACH transaction considered as a virtual check which forms the payment device, and/or the account identified including the RTN as the payment device.

Alternately or additionally, it is contemplated within the scope of the instant disclosure that an entity upstream of the network operator 22 in the transaction handling process 10, for example the acquirer 20, may provide the transaction request submitted to the network operator with a predetermined characteristic that is meant to signal to the network operator 22 to invoke the improved merchant data cleansing process. For example, identifying information (such as a flag) may be appended to the transaction data before submission of the transaction request to the network operator for processing. In that case, the determination 118 is an inspection of the transaction request for this flag or other predetermined characteristic. This method has the benefit of permitting the acquirer 20 or other upstream entity to selectively invoke the improved merchant data cleansing process.

Upon determining that a transaction is eligible for processing under the improved cleansed merchant data program based upon the merchant identity 128 and other steps as discussed, the transaction is forwarded 134 to invoke the improved cleansed merchant data process 136. The improved cleansed merchant data process looks to a pre-established cleansed merchant database, including cleansed merchant data, i.e. merchant identification data that may be empirically verified and/or formatted according to a more identifiable and/or useful standard from the perspective of the issuer 24 and/or the device holder 12.

Cleansed merchant data may include, without limitation, cleansed versions of the merchant's “Doing Business As” (or DBA) name, which is a trade name by which the business is known to its customers irrespective of its legal entity name; the merchant's street address; the merchant's city; the merchant's postal code; the merchant's state; the merchant's country. These fields correspond to the set of data fields typically included among transaction data supplied by an acquirer 20. According to the present and related disclosures, the cleansed data fields will be formatted to a defined standard, including abbreviations, etc. Cleansed data field may also include data that is verified as accurate, even though such cleansed data may differ from the merchant data supplied by the acquirer 20. Some or all of the cleansed data fields may exist for a given merchant. The fields that are replaced according to the present disclosure may be indicated to the issuer 24 according to further embodiments of the present disclosure.

A determination is made 138 whether a match exists in the merchant database that corresponds with the merchant information included in the transaction data supplied by the acquirer 20. The process of determining whether a match exists 138 may also include a supplemental determination whether the merchant data supplied by the acquirer 20 is to be replaced, based upon criteria to be described hereinafter.

If no match exists between the merchant data included in the transaction and the cleansed merchant database 140, the transaction is processed at 142 by leaving the merchant data supplied by the acquirer 20 in place. Optionally, the transaction data may be supplemented to indicate or confirm that the improved merchant data cleansing program service has been applied to the transaction. Still further, optionally or additionally, the supplemental data may indicate the absence of a corresponding match in the cleansed merchant database.

It may be the case that a match is found between the merchant data supplied by the acquirer 20 in the transaction data and the cleansed merchant database. Notwithstanding, one or more reasons to be described hereinafter may indicate that the merchant data is not replaced 144. One such reason is that the merchant data included with the transaction data provided by the acquirer 20 is a complete match to the merchant data in the cleansed merchant database. In that case, the transaction is processed at 146 by leaving the merchant data supplied by the acquirer 22 in place. Optionally, the transaction data may be supplemented to indicate or confirm that the improved merchant data cleansing program service has been applied to the transaction. Still further, optionally or additionally, the supplemental data may indicate the presence of a corresponding match in the improved cleansed merchant database, and/or that it corresponds to the merchant data provided by the acquirer 20.

Furthermore, it may be the case that a match is found between the merchant data supplied by the acquirer 20 in the transaction data and the cleansed merchant database, and further that the merchant data supplied by the acquirer 20 with the transaction data is to be replaced 148. In that case, the transaction is processed 150 by replacing the merchant data supplied by the acquirer 22 with the corresponding cleansed merchant data. Optionally, the transaction data may be supplemented to indicate or confirm that the improved merchant data cleansing program service has been applied to the transaction. Still further, optionally or additionally, the supplemental data may indicate the presence of a corresponding match in the cleansed merchant database, that some or all of the merchant data has been substituted, (specifically which fields), and/or include the original merchant data provided by the acquirer 20 in addition to the cleansed merchant data.

Under any of the three processing scenarios 142, 146 or 150 described above, the transaction processing then proceeds via one of 152, 154 or 156, respectively, to deliver the transaction data to the issuer. The issuer receives the clearing data 158, possibly including the cleansed merchant data and/or supplemental data as described above. Thereafter, the improved merchant data cleansing process according to the first embodiment of the present disclosure is considered terminated 160.

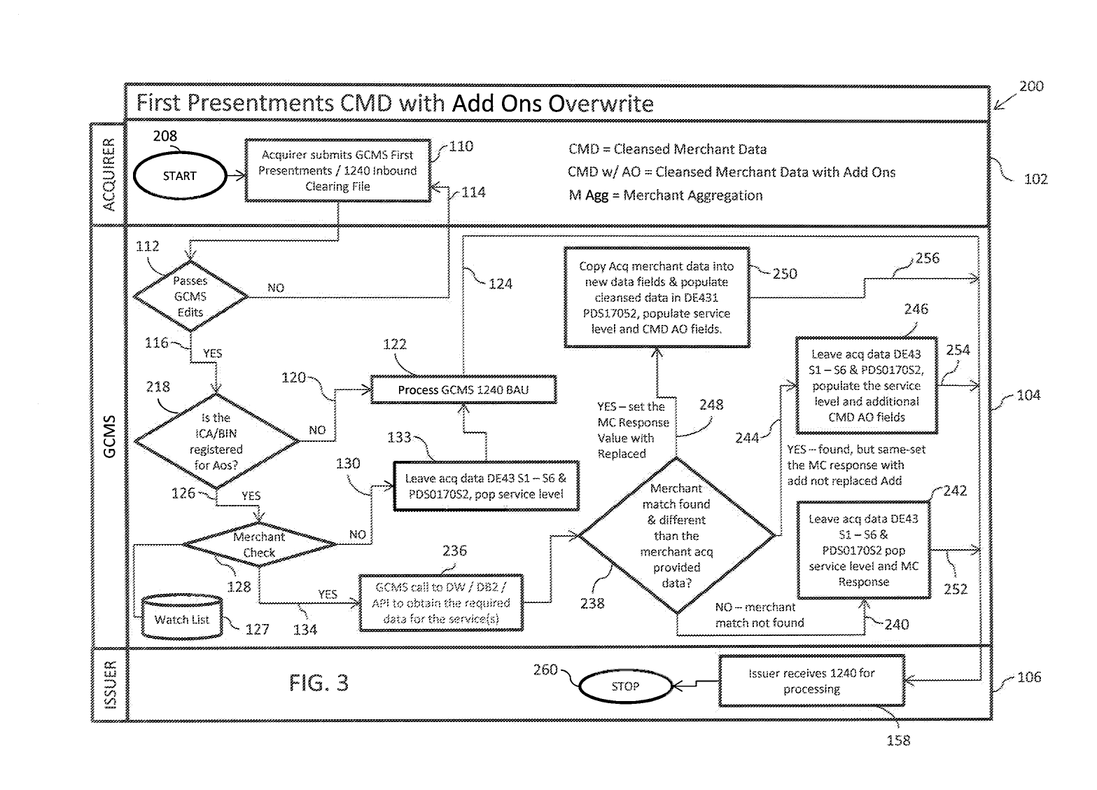

Turning now to FIG. 3, illustrated is a flowchart, generally 200, describing the process for implementing improved merchant data cleansing according to a second embodiment of the instant disclosure. Where the second embodiment is the same as or similar to the first, like reference numerals appear in FIG. 3 as in FIG. 2, and a complete description of these features will be omitted, for the sake of brevity and in light of the foregoing full description.

As a matter of nomenclature, the second embodiment includes so-called “add-on” data with the cleansed merchant data. Add-on data is data that does not merely replace the merchant data provided by the acquirer 20 in the transaction data with a more palatable form or content of cleansed merchant data. Add-on data is data specific to the merchant that would not have been included in the transaction clearing record according to present standards, but is nonetheless useful or valuable to the issuer. Add-on data may include, without limitation: a legal entity name of the merchant (contrasted with the merchant's DBA name); a relative percentage source of the merchant's sales, for example whether they originate in retail stores (aka, brick-and-mortar, or simply brick), on the internet or online, and any other sales channels; merchant URL.

From the beginning of the second embodiment process 208, the second embodiment deviates from the first embodiment of the present disclosure in that the verification of ICA and/or BIN 218 of an incoming transaction is against a separate list as compared with the first embodiment. This permits the network operator 22 to simultaneously offer multiple levels of the improved merchant data cleansing service to various issuer 24 clients, or to different subsets of ICA and/or BIN number ranges associated with a single issuer 24 client, even simultaneously.

As execution of the second embodiment proceeds, after step 218 if it is determined positively that the merchant is registered for add-on data cleansing, a “merchant check” is performed at step 128. As previously, the merchant check 128 includes a check of the identity of the merchant as contained in the transaction request with a list of merchants on a “watch-list” 127. If it is determined that the identity of the merchant is contained in the merchant watch-list 127, execution proceeds 134 to step 236, where the cleansed merchant data process 236 is invoked. Otherwise execution proceeds from step 128 to steps 130 and 133. In this manner, transactions associated with merchants that have a higher propensity to cause a DNR transaction may be targeted and submitted for cleansing without the need to submit all transactions for cleansing.

Upon determining that a transaction is eligible for processing under the improved merchant data cleansing program with add-on data based upon the merchant identity 128, the transaction is forwarded 134 to invoke the improved merchant data cleansing process including add-on data 236. The improved merchant data cleansing process looks to a pre-established cleansed merchant database, further including add-on data of the type described above, among other pertinent merchant-specific add-on data.

A determination is made 238 whether a match exists in the merchant database that corresponds with the merchant information included in the transaction data supplied by the acquirer 20. The process of determining whether a match exists 238 may also include a supplemental determination whether the merchant data supplied by the acquirer 20 is to be replaced, based upon criteria to be described hereinafter.

If no match exists between the merchant data included in the transaction and the cleansed merchant database 240, the transaction is processed at 242 by leaving the merchant data supplied by the acquirer 20 in place. Optionally, the transaction data may be supplemented to indicate or confirm that the improved merchant data cleansing program service has been applied to the transaction. Still further, optionally or additionally, the supplemental data may indicate the absence of a corresponding match in the cleansed merchant database.

It may be the case that a match is found between the merchant data supplied by the acquirer 20 in the transaction data and the cleansed merchant database. Notwithstanding, one or more reasons described hereinafter may indicate that the merchant data is not to be replaced 244. One such reason is that the merchant data included with the transaction data provided by the acquirer 20 is a complete match to the merchant data in the cleansed merchant database. In that case, according to the second embodiment, the transaction is processed at 246 by leaving the merchant data supplied by the acquirer 22 in place, while appending the add-on data. Optionally, the transaction data may be supplemented to indicate or confirm that the improved merchant data cleansing program with add-on service has been applied to the transaction. Still further, optionally or additionally, the supplemental data may indicate the presence of a corresponding match in the cleansed merchant database, and/or that the cleansed merchant data corresponds to the merchant data provided by the acquirer 20. In connection with the indication of add-on service level applied, and the presence of add-on data, the issuer will be aware that merchant data was verified against the cleansed merchant database, and that the add-on service was provided.

Furthermore, the case may be that a match is found between the merchant data supplied by the acquirer 20 in the transaction data and the cleansed merchant database, and further that the merchant data supplied by the acquirer 20 with the transaction data is to be replaced 248. In that case, the transaction is processed 250 by replacing the merchant data supplied by the acquirer 22 with the corresponding cleansed merchant data, and appending the add-on data. Optionally, the transaction data may be supplemented to indicate or confirm that the improved merchant data cleansing program service has been applied to the transaction. Still further, optionally or additionally, the supplemental data may indicate the presence of a corresponding match in the cleansed merchant database, that some of all of the merchant data has been substituted (specifically which fields), and/or include the original merchant data provided by the acquirer 20 in addition to the cleansed merchant data.

It may further be the case that a match between the merchant data supplied by the acquirer 20 the cleansed merchant data exists, and possibly the two fully correspond, however, no supplemental add-on data is available. In this case, the transaction may be handled as described above with respect to the first embodiment in either of those cases, with the optional exception that the data may be supplemented to indicate the level of service applied, i.e. improved merchant data cleansing program with add-on, but the absence of add-on data produced the result subsequently transmitted to the issuer 24.

Under any of the processing scenarios of the second embodiment, including 242, 246 or 250 described above, the transaction processing then proceeds via one of 252, 254 or 256, respectively, to deliver the transaction data to the issuer. The issuer receives the clearing data 158, possibly including the cleansed merchant data, supplemental data and/or add-on data as described above according to this second embodiment. Thereafter, the improved merchant data cleansing process according to the second embodiment of the present disclosure is considered terminated 260.

Moreover, it is presently contemplated that the second embodiment as described may include and incorporate all features of the first embodiment, however this is not necessarily required to be the case. The network operator may find it advantageous to offer the add-on data service separate and apart from the improved merchant data cleansing service.

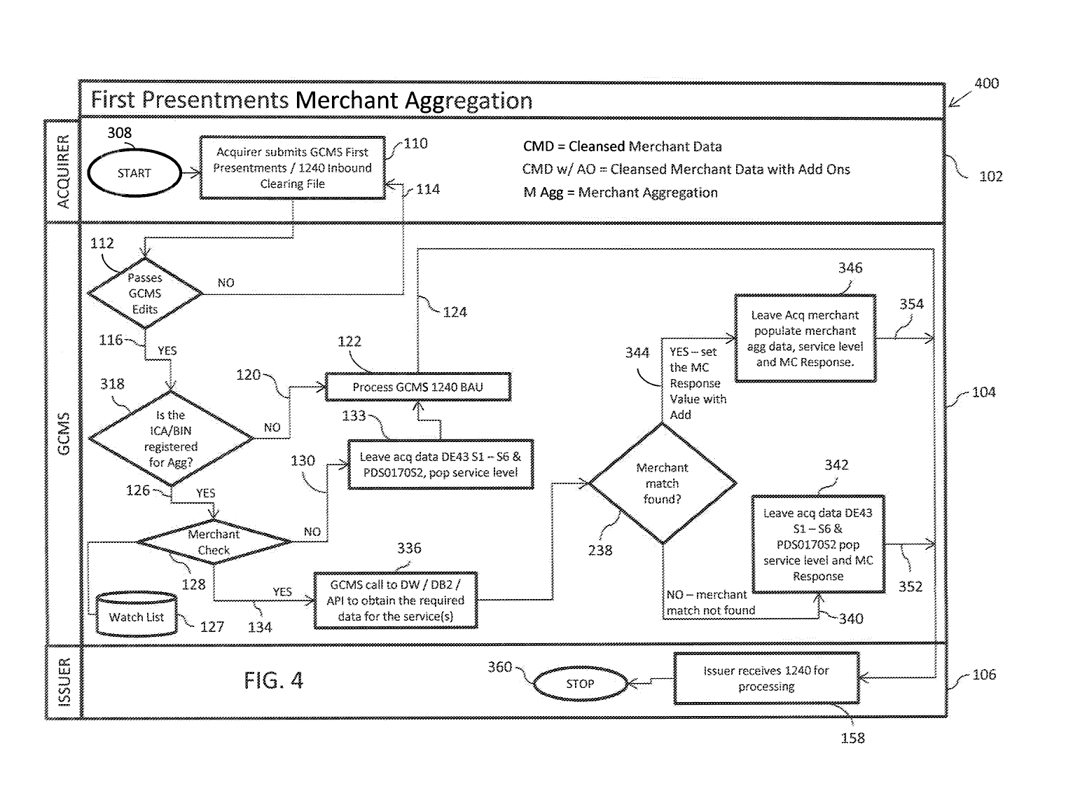

Turning now to FIG. 4, illustrated is a flowchart, generally 400, describing the process for implementing improved merchant data cleansing according to a third embodiment of the instant disclosure. Where the third embodiment is the same as or similar to the first or second, like reference numerals appear in FIG. 4 as in FIG. 2 or 3, and a complete description of these features will be omitted, for the sake of brevity and in light of the foregoing full description.

As a matter of nomenclature, the third embodiment includes so-called “Merchant Aggregation” data with the cleansed merchant data. Merchant aggregation data is data that does not replace the merchant data provided by the acquirer 20 in the transaction data with more palatable form or content of cleansed merchant data. Merchant aggregation data is data related to the merchant when considered in the aggregate, i.e. data that is beyond the scope of information concerning the particular merchant where the transaction is consummated, and more particularly where that merchant is part of a larger aggregation (e.g. chain or franchise). Merchant aggregation would not have been included in the transaction clearing record according to present standards, but is nonetheless useful or valuable to the issuer. Merchant aggregation data may include, without limitation: An identifier of the aggregate merchant concern; the name of the aggregate merchant concern; an industry code related to the line of business in which the aggregate merchant operates; a super-industry code related to a broad classification in which the industry code operates; an identifier related to whether the aggregate merchant is a key aggregate merchant to be identified based on a specified criteria; a channels of distribution code indicating which channels of distribution are utilized by the aggregate merchant and optionally the relative proportions of the aggregate merchant's sales in each of those channels; a North American Industry Classification System (NAICS) code corresponding to the aggregate merchant; an Australian and New Zealand Standard Industrial Classification (ANZSIC) code related to an aggregate merchant; any public classification system identification code related to the aggregate merchant, or a parent aggregate merchant identifier where the aggregate merchant is itself under the auspices of a parent entity.

From the beginning of the third embodiment process 308, the third embodiment deviates from the first embodiment of the present disclosure in that the verification of ICA and/or BIN 318 of an incoming transaction will be against a separate list as compared with the first or second embodiments. This permits the network operator 22 to simultaneously offer multiple levels of the service to various issuer 24 clients, or to different subsets of ICA and/or BIN number ranges associated with a single issuer 24 client, even simultaneously.

Upon determining that a transaction is eligible for processing under the improved merchant data cleansing program with add-on data based upon the merchant identity 128 (as discussed with the present disclosure herein, wherein the data identifying the merchant included in the transaction request is compared with a list of merchants on a watch-list), the transaction is forwarded 134 to invoke the improved merchant data cleansing process including merchant aggregation data 336. The merchant aggregation data process looks to a pre-established merchant aggregation database, further including merchant aggregation data, for example including the type described above, among other pertinent aggregate merchant-specific data.

A determination is made 338 whether a match exists in the aggregate merchant database that corresponds with the merchant information included in the transaction data supplied by the acquirer 20. If no match exists between the merchant data included in the transaction and the aggregate merchant database 340, the transaction is processed at 342 by leaving the merchant data supplied by the acquirer 20 in place. Optionally, the transaction data may be supplemented to indicate or confirm that the aggregate merchant data program service has been applied to the transaction. Still further, optionally or additionally, the supplemental data may indicate the absence of a corresponding match in the aggregate merchant database.

Where a match is found between the merchant data supplied by the acquirer 20 in the transaction data and the aggregate merchant database 344, the transaction is processed at 346 by leaving the merchant data supplied by the acquirer 22 in place, while appending the aggregate merchant data. Optionally, the transaction data may be supplemented to indicate or confirm that the aggregate merchant data program has been applied to the transaction. Still further, optionally or additionally, the supplemental data may indicate the presence of a corresponding match in the aggregate merchant database, and/or that the cleansed merchant data corresponds to the merchant data provided by the acquirer 20. In connection with the indication of add-on service level applied, and the presence of add-on data, the issuer will be aware that merchant data was verified against the cleansed merchant database, and that the aggregate merchant service was provided.

Furthermore, circumstances may arise that a match is found between the merchant data supplied by the acquirer 20 in the transaction data and the cleansed merchant database, and further that the merchant data is to be supplied by the acquirer 20 with the transaction data to be replaced 248. In that case, the transaction is processed by replacing the merchant data supplied by the acquirer 22 with the corresponding cleansed merchant data, and appending the add-on data. Optionally, the transaction data may be supplemented to indicate or confirm that the improved merchant data cleansing program service has been applied to the transaction. Still further, optionally or additionally, the supplemental data may indicate the presence of a corresponding match in the cleansed merchant database, that some of all of the merchant data has been substituted, specifically which fields, and/or include the original merchant data provided by the acquirer 20 in addition to the cleansed merchant data.

Under any of the processing scenarios of the third embodiment, including 342 or 346 described above, the transaction processing then proceeds via one of 352 or 354, respectively, to deliver the transaction data to the issuer. The issuer receives the clearing data 158, possibly including the merchant data, supplemental data and/or merchant aggregation data as described above. Thereafter, the improved merchant data cleansing process according to this embodiment of the present disclosure is considered terminated 360.

Moreover, it is presently contemplated and described above that the third embodiment may operate largely independently of the first and/or second, i.e. there is no express consideration of improved merchant data cleansing, verification, and/or substitution. All features of the first or second embodiments, therefore, are not necessarily required to operation of the third embodiment. The network operator 22 may find it advantageous to offer the merchant aggregation data service separate and apart from the improved merchant data cleansing and/or add-on data services. However, the levels of service described above by way of the various and/or multiple embodiments are in no way mutually exclusive, and they may be combined in whole or in any constituent part.

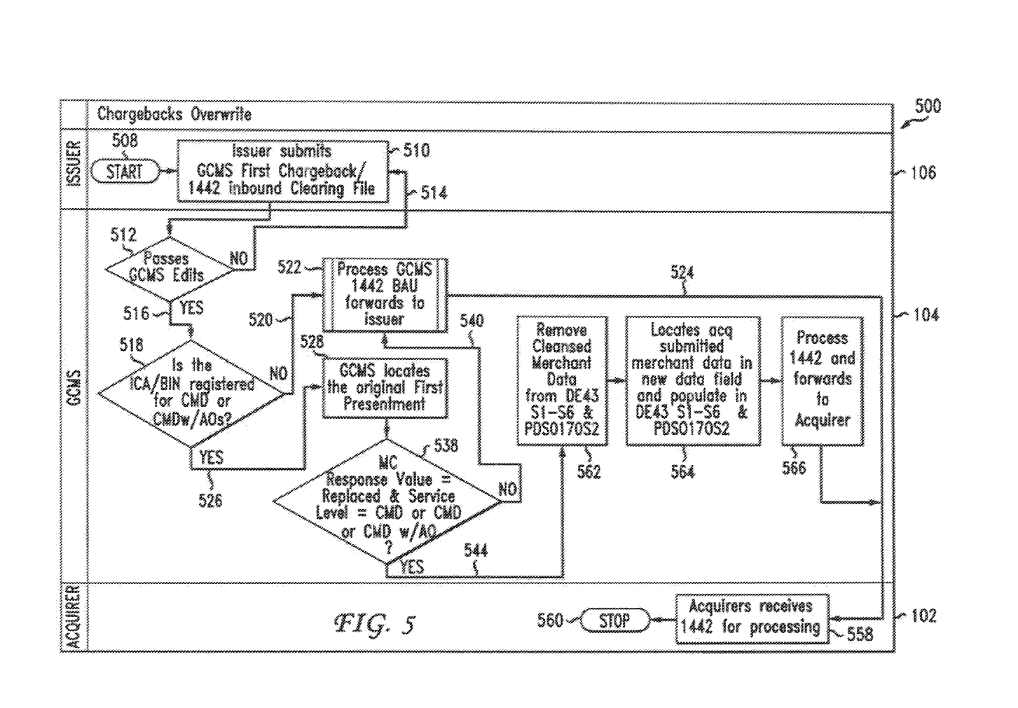

Turning now to FIG. 5, illustrated is a flow chart, generally 500, for a charge-back procedure according to the present disclosure. A charge-back is the process by which an issuer 24 disputes the validity of a transaction, often at the behest of the device holder 12 and/or a party having financial ownership or responsibility for the account(s) funding the payment device 14, if not solely the device holder 12, and often concerning quality or non-delivery of goods or services purchased using the device transaction. The charge-back flowchart is again vertically divided into sections 106, 104 and 102, representing respective actions undertaken by the issuer 24, network operator 22 and acquirer 20, respectively. These vertical divisions are in a reverse order as compared to FIGS. 2-4, in part because the charge-back is initiated by the issuer 24, which was generally the reverse of the flow directions, as between the respective parties, depicted in FIGS. 2-4.

The issuer 24 initiates a charge-back 508, and submits the charge-back message 510. The network operator 22 checks the submission for conformance with its standards 512. If found out of compliance, it is rejected and returned 514 to the issuer 24. If found in compliance, the process proceeds 516. The network operator 20 next determines at 518 whether the ICA and/or BIN derived from the payment device 14 that is identified in or associated with the charge-back request is registered for participation in the improved merchant data cleansing program, with or without add-on or merchant aggregation data. If the ICA and/or BIN is not found to be registered for the improved merchant data cleansing program 520, then the charge-back is processed normally at 522, i.e. without invoking the features of the improved merchant data cleansing program. The normally processed charge-back is then forwarded 524 onto the issuer 24.

On the other hand, upon determining that the ICA and/or BIN in question is registered for the improved merchant data cleansing program 526, the network operator searches its records for the original or first presentment of the underlying transaction. With reference to the original presentment of the transaction underlying the charge-back request message, the network operator 22 determines whether the merchant data was substituted by application of the improved merchant data cleansing program 538, whether with or without add-on or merchant aggregation data applied. If the merchant data was not substituted for the underlying transaction 540, then the charge-back request of processed normally 522, and routed 524 to the acquirer 20.

On the other hand, if it is determined that the improved merchant data cleansing program has been applied 544, the application of the cleansed merchant data should be reversed, at least so that the merchant data in the charge-back request will correspond to the merchant data submitted by the acquirer 20 in the first instance. Towards accomplishing this, the cleansed merchant data that had been substituted in the transaction is removed from the charge-back request message 562. The merchant information submitted by the acquirer 20 in the original presentment of the transaction clearing record is then re-populated in the applicable merchant data fields 564. Having restored the merchant data to its original state, and thus immediately recognizable to the acquirer 20, the charge-back request is forwarded 566 on to the acquirer 20. The issuer receives the charge-back data 558, including the original merchant data as submitted with the initial transaction. Thereafter, the charge-back process according to the present disclosure is considered terminated 560.

The foregoing processes have been described with reference to what it known in the industry as a dual-message acquirer. This term is used to describe what most consumers understand as a credit transaction. The dual-message process is also applicable to offline debit transactions. On the other hand, there also exists a single-message transaction (a.k.a. Single Message System or alternately MDS), typically involving a debit card linked to or drawing from a demand deposit account in an online transaction. In that case, the transaction is authorized by a PIN number input by the device holder 12 optionally, in addition to a signature. A dual-message transaction involves, as the name suggests, two messages to complete a transaction; a single-message only one. However, the application of the improved merchant data cleansing program and/or optionally supplemental, add-on or merchant aggregation data is not substantively affected by the use of either single- or dual-message protocol, nor the involvement of a merchant data service provider as intermediary between the network operator 22 and the issuer 24.

It will be appreciated by those skilled in the art that the cleansed merchant data, add-on data and/or merchant aggregation data as described above may be operated by a machine operator having a suitable interface mechanism, and/or more typically in an automated manner, for example by operation of a network-enabled computer system or computing device including a processor executing a system of instructions stored on a machine-readable medium, RAM, hard disk drive, or the like. The instructions cause the processor to operate in accordance with the present disclosure.

Turning then to FIG. 6, illustrated is a network-enabled system, generally 600, as a further embodiment of the present disclosure. A telecommunication network 612 enables information exchange among the various components of the system. Network 12 may comprise an Internet, an intranet, Ethernet, virtual private network (VPN), cellular, WiFi, or substantially any means or modality by which telecommunication machines, or components thereof, exchange data or information with each other. The network 612 may comprise a composite of several different of these or other telecommunication modes. The network 612 may connect components that are physically co-located, for example a computer or processing device that shares an internal databus (e.g. PCI, SATA) with one or more storage means.

Point-of-sale 614 represents the point of origination of a transaction, whether tangible (e.g. brick-and-mortar or other location), internet-based, as in an e-commerce transaction regardless of the physical location of the device holder 12 or the merchant 16. Point of sale 614 for the purposes of FIG. 6 further includes any intermediaries (third-party payment provider 18, acquirer 20, etc.) as may be necessary to deliver the transaction data to the network operator 22.

Network operator 22 maintains operational control of a server 616 including a processing device 622 for carrying out transaction processing and optionally storage 624 for maintaining instructions executable by the processor (computing device) (see FIG. 7). Network operator 22 also maintains access between the transaction processing server 616 and a database 618 or other suitable means for storage of merchant information. The database 618 includes cleansed merchant data entries, merchant add-on information entries, and merchant aggregation entries. Server 616 and database 618 may each include plural, several, shared, divided and/or redundant machines as the network operator 22 finds necessary or convenient, including the necessary operational capacity to divide the processing of volumes of transactions and/or access to data entries among such plural, etc., machines. The dataflow connection between the server 616 and the database 618 may make use of the network 612, or employ a more direct connection 620.

FIG. 7 illustrates schematically a representative server 616 of the system 600 in still a further embodiment of the present disclosure. The server 616 includes at least a processor, computing device, or CPU 622 which is operative to act on a program of instructions stored on a computer-readable medium 624. Execution of the program of instructions causes the processor to carry out, for example, the methods described above according to the various embodiments. It may further or alternately be the case that the processor (computing device) 622 comprises application-specific circuitry including the operative capability to execute the prescribed operations integrated therein. The server 616 includes a network interface 626 for communication with the network 612. Optionally or additionally, a data entry device 628 (e.g. keyboard, mouse, trackball, pointer, etc.) facilitates human interaction with the server, as does an optional display 630.

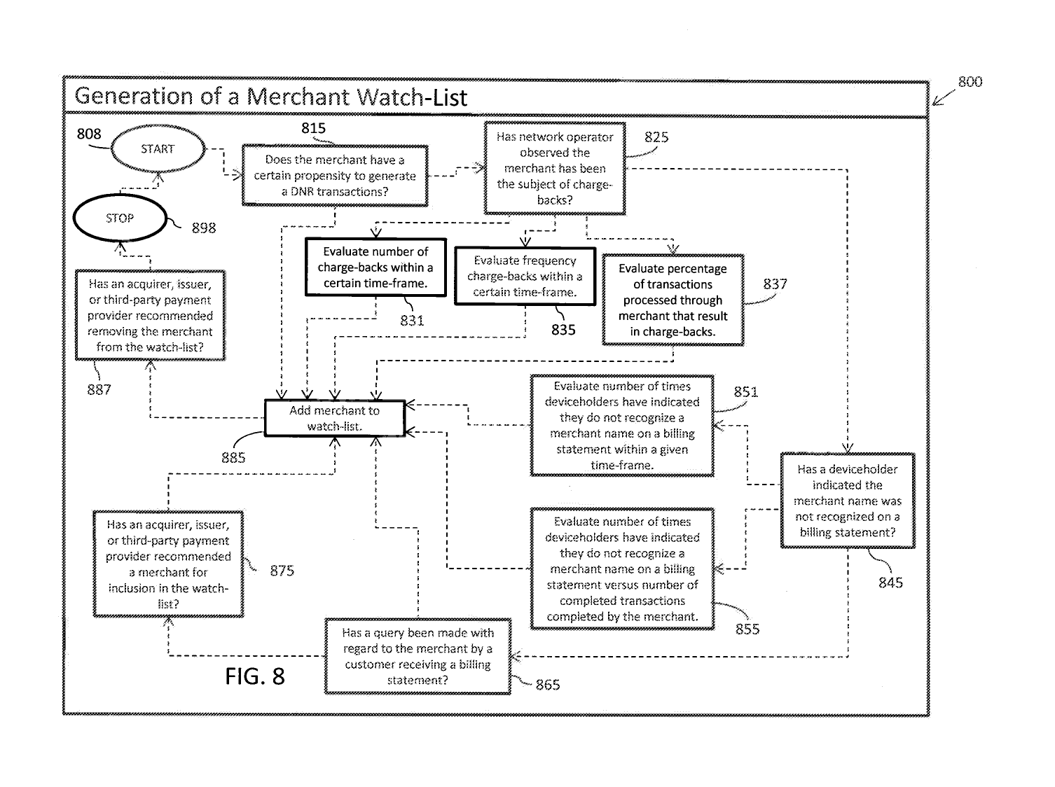

Turning now to FIG. 8, illustrated is a flowchart 800, describing a process of generation of a “watch-list” 127 in an embodiment of the invention. As stated previously, this watch-list may be maintained in a “data-warehouse” on a server maintained by the network operator 20, or any other party to a payment device transaction. Also as stated previously, a computer or some sort of computing device is a necessary element to perform the vast amounts of data organization necessary to operate the presently disclosed method, system, and computer software product. The series of steps discussed within FIG. 8 may be performed in any order, and with or without the inclusion of certain steps. Alternately, multiple steps may be performed when making a determination of whether or not to include a merchant on a watch-list (e.g. a computing device may first determine as with step 815, whether a merchant has a certain propensity to generate a DNR transaction, then later at step 865 determine whether a query has been made with regard to the merchant by a customer receiving a billing statement, and only if both of these conditions are true adding a merchant to a watch-list). Any combination of steps is possible in the decision whether to add a merchant to a watch-list 885. Execution of a process of generation of a watch-list 127 begins at “START,” 808 in an embodiment of the invention. At step 815 a determination is made whether the merchant has a certain propensity to generate a DNR transaction. At step 825 the network operator 22 simply observes whether the merchant 16 has been the subject of charge-backs. If so, the merchant may be directly added to the watch-list 885, or execution may proceed to any or all of steps 831, 835, and 837 where separate determinations are made. Any, all, or none of steps 831, 835, and 837 may take place when determining whether to include a merchant on the watch-list. At step 831a computing device determines a number of charge-backs made within a certain timeframe with regard to the merchant. The time-frame may be, by means of non-limiting example, one-month, two months, six months, and/or twelve months. At step 835 the frequency of charge-backs occurring within a certain time-frame are evaluated. At step 837 the computing device evaluates a percentage of transactions processed through the merchant that resulted in charge-backs, absolutely or over a certain time-frame. If any one or combination of steps 831, 835, and 837 are true, the merchant may be added to the merchant watch-list 885. At step 845 a determination is made whether a deviceholder has previously indicated whether the name of the merchant was not recognized on a billing statement. If so, the merchant may be added directly to the merchant watch-list 885, or steps 851 and 855 may take place. At step 851, an evaluation is made of a number of times deviceholders have indicated they do not recognize a merchant's name on a billing statement 26 within a given time-frame. The time-frame may be the same as that previously discussed or any other. At step 855 the computing device evaluates a number of times deviceholders have indicated they do not recognize a merchant name on a billing statement 26, versus the number of completed transactions completed by the merchant. In effect, a percent of deviceholders not recognizing a merchant name on a billing statement 26 is considered, in view of a threshold limit for determining whether or not a merchant should be included on the merchant watch-list. If step 851 and/or step 855 indicates assignment to the merchant watch-list is appropriate, the merchant is added to the watch-list 885, in an embodiment of the invention. At step 865 it is determined whether a query has been made previously with regard to the merchant by a customer receiving a billing statement. At step 875 a further determination is made whether an acquirer, issuer, or third-party payment provider has recommended a merchant for inclusion on the watch-list. Step 875 only takes place if an acquirer, issuer, or third-party payment provider has such rights. If any one or a number of these steps 815 through 875 indicates an assignment to the merchant watch-list is appropriate (step 885), this is performed. At step 887 an acquirer, issuer, or third-party payment provider may recommend removing the merchant from the watch-list. Again, step 887 only takes place if an acquirer, issuer, or third-party payment provider has such rights. Execution then proceeds to “STOP,” 898, and then execution may reinitiate with further data regarding merchants at “START” 808.

As would be appreciated by one of skill in the art, the present disclosure will comply with all relevant state, federal, and international laws regarding data privacy.

Variants of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

We claim:

1. A method of utilizing a computing device to intermediate cashless transactions from an acquirer involving a payment device issued by an issuer, the method comprising:
receiving a transaction request from the acquirer on behalf of a merchant in a transaction clearing record, the transaction request including data identifying the merchant and the payment device;
performing a merchant check by comparing the data identifying the merchant included in the transaction request with a list of merchants on a watch-list;
in response to determining that the merchant included in the transaction request is included in the watch-list, searching a first database to determine if a merchant entry exists in the first database corresponding with the data identifying the merchant included in the transaction request, the first database including cleansed merchant data entries;
in response to determining that a match exists in the first database between a cleansed merchant data entry and the data identifying the merchant in the transaction request, determining whether the data identifying the merchant in the transaction request should be substituted with the matching cleansed merchant data entry;
in response to determining that the data identifying the merchant should be substituted with the matching cleansed merchant data entry, performing the data substitution; and
forwarding the transaction request including the substituted cleansed merchant data entry to the issuer of the payment device.

2. The method according to claim 1, further comprising:
appending a supplement to the transaction data, the presence of which indicates to the issuing entity that the searching was performed.

3. The method according to claim 2, wherein the supplement is further related to the result of the determining if a match exists in the first database.

4. The method according to claim 1, wherein performing the data substitution further comprises:
appending the data identifying the merchant included with the transaction request to the transaction request having the substituted cleansed merchant data.

5. The method according to claim 1, wherein making the determination that the data identifying the merchant in the transaction request should not be substituted with the matching cleansed merchant data entry is made where the data identifying the merchant in the transaction request is a complete match with the corresponding cleansed merchant data entry.

6. The method according to claim 1, further comprising:
receiving a charge-back request from the issuer pertaining to a cleared transaction request;
determining whether the data identifying the merchant in the cleared transaction request has been substituted with the matching cleansed merchant data entry;
in response to determining affirmatively that the data identifying the merchant in the cleared transaction request had been substituted with the matching cleansed merchant data entry, reversing the substitution; and
forwarding the charge-back request to the acquirer of the cleared transaction.

7. The method according to claim 1, wherein the computing device adds a merchant to the watch-list if selectively one of a minimum number and minimum percentage of previous transactions associated with the merchant have resulted in charge-backs within a given time-frame.

8. The method according to claim 7 wherein the time-frame is selectively one of one month, two months, six months, and one year.

9. The method according to claim 1, wherein the computing device adds a merchant to the watch-list if a network operator determines DNR transactions associated with the merchant have been reported by customers.

10. The method according to claim 1, wherein the computing device adds a merchant to the watch-list if at least one of the acquirer, the issuer, and a third-party payment provider recommends the merchant for inclusion in the watch-list.

11. The method of claim 1, wherein the watch-list is housed in a data-warehouse maintained by the network operator.

12. A system for intermediating cashless transactions from an acquirer involving a payment device issued by an issuer, the system comprising:
a computing device; and
a non-transitory computer-readable storage medium having a program of instruction thereon which when executed by the computing device causes the system to:
receive a transaction request from the acquirer on behalf of a merchant in a transaction clearing record, the transaction request including data identifying the merchant and the payment device;
perform a merchant check by comparing the data identifying the merchant included in the transaction request with a list of merchants on a watch-list;
in response to determining that the merchant included in the transaction request is included in the watch-list, search a first database to determine if a merchant entry exists in the first database corresponding with the data identifying the merchant included in the transaction request, the first database including cleansed merchant data entries;
in response to determining that a match exists in the first database between a cleansed merchant data entry and the data identifying the merchant in the transaction request, determine whether the data identifying the merchant in the transaction request should be substituted with the matching cleansed merchant data entry;
in response to determining that the data identifying the merchant should be substituted with the matching cleansed merchant data entry, perform the data substitution; and
forward the transaction request including the substituted cleansed merchant data entry to the issuer of the payment device.

13. The system according to claim 12, wherein the program of instruction, when executed by the computing device, further causes the system to:
append a supplement to the transaction data, the presence of which indicates to the issuing entity that the searching was performed.

14. The system according to claim 13, wherein the supplement is further related to the result of the determination if a match exists in the first database.

15. The system according to claim 12, wherein the program of instructions, when executed by the computing device, further causes the system when performing the data substitution to:
append the data identifying the merchant included with the transaction request to the transaction request having the substituted cleansed merchant data.

16. The system according to claim 12, wherein the determination that the data identifying the merchant in the transaction request should not be substituted with the matching cleansed merchant data entry is made where the data identifying the merchant in the transaction request is a complete match with the corresponding cleansed merchant data entry.

17. The system according to claim 12, wherein the program of instruction, when executed by the computing device, further causes the system to:
receive a charge-back request from the issuer pertaining to a cleared transaction request;
determine whether the data identifying the merchant in the cleared transaction request has been substituted with the matching cleansed merchant data entry;
in response to determining affirmatively that the data identifying the merchant in the cleared transaction request had been substituted with the matching cleansed merchant data entry, reverse the substitution; and
forward the charge-back request to the acquirer of the cleared transaction.

18. The system according to claim 12, wherein the computing device adds a merchant to the watch-list if selectively one of a minimum number and minimum percentage of previous transactions associated with the merchant have resulted in charge-backs within a given time-frame.

19. The system according to claim 18 wherein the time-frame is selectively one of one month, two months, six months, and one year.

20. The system according to claim 12, wherein the computing device adds a merchant to the watch-list if a network operator determines DNR transactions associated with the merchant have been reported by customers.

21. The system according to claim 12, wherein the computing device adds a merchant to the watch-list if at least one of the acquirer, the issuer, and a third-party payment provider recommends the merchant for inclusion in the watch-list.

22. The system according to claim 12, wherein the watch-list is housed in a data-warehouse maintained by the network operator.

23. A method of utilizing a computing device to intermediate cashless transactions from an acquirer involving a payment device issued by an issuer, the method comprising:
receiving a transaction request from the acquirer on behalf of a merchant in a transaction clearing record, the transaction request including data identifying the merchant and the payment device;
performing a merchant check by comparing the data identifying the merchant included in the transaction request with a list of merchants on a watch-list;
in response to determining that the merchant included in the transaction request is included in the watch-list, searching a first database to determine if a merchant entry exists in the first database corresponding with the data identifying the merchant included in the transaction request, the first database including merchant aggregation data entries;
in response to determining a match exists in the database between a merchant aggregation data entry and the data identifying the merchant in the transaction request, appending the merchant aggregation data entry to the transaction request before forwarding the transaction request to the issuer of the payment device; and
forwarding the transaction request including the appended merchant aggregation data entry to the issuer of the payment device.

24. The method according to claim 23, further comprising:
appending a supplement to the transaction data, the presence of which indicates to the issuing entity that the searching was performed.

25. The method according to claim 24, wherein the supplement is further related to the result of the determining if a match exists in the first database.

26. The method according to claim 23, wherein the computing device adds a merchant to the watch-list if selectively one of a minimum number and minimum percentage of previous transactions associated with the merchant have resulted in charge-backs within a given time-frame.

27. The method according to claim 26 wherein the time-frame is selectively one of one month, two months, six months, and one year.

28. The method according to claim 23, wherein the computing device adds a merchant to the watch-list if a network operator determines DNR transactions associated with the merchant have been reported by customers.

29. The method according to claim 23, wherein the computing device adds a merchant to the watch-list if at least one of the acquirer, the issuer, and a third-party payment provider recommends the merchant for inclusion in the watch-list.

30. The method of claim 23, wherein the watch-list is housed in a data-warehouse maintained by the network operator.
